(19) United States
(12) Patent Application Publication
(10) Pub. No.: US 2023/0306055 A1
(43) Pub. Date: Sep. 28, 2023

(54) SEARCH DEVICE, SEARCH METHOD, AND RECORDING MEDIUM

(71) Applicant: NEC Corporation, Minato-ku, Tokyo (JP)

(72) Inventors: Yuki ARISATO, Tokyo (JP); Takuya Sera, Tokyo (JP)

(73) Assignee: NEC Corporation, Minato-ku, Tokyo (JP)

(21) Appl. No.: 18/033,038

(22) PCT Filed: Oct. 29, 2020
(86) PCT No.: PCT/JP2020/040644

§ 371 Date: Apr. 20, 2023

(51) Int. Cl. G06F 16/532; G06V 10/44; G06V 10/74; G06F 16/538; G06F 16/583

(52) U.S. Cl. CPC G06F 16/532; G06V 10/44; G06V 10/761; G06F 16/538; G06F 16/583

(57) ABSTRACT

In the search device, the image feature calculation means calculates an image feature based on an animal image of an animal. The attribute feature calculation means calculates an attribute feature based on attribute information of the animal. The appearance feature generation means generates an appearance feature based on the image feature and the attribute feature corresponding to the animal. The similarity calculation means calculates similarity between the animal image and a target animal image based on the appearance feature corresponding to the animal image and the appearance feature corresponding to the target animal image.

### TECHNICAL FIELD

The present disclosure relates to a technique of searching for an animal.

### BACKGROUND ART

Dogs and cats protected by public health centers and public care facilities may be searched for a variety of reasons, such as looking for a foster or a strayed pet dog. As a method of searching for a protected dog, there is known a method of designating attribute information such as the type or gender of the dog to be searched, for example, and searching for a protected dog similar to the dog.

Patent Document 1 describes an animal search system for matching animals using a combination of images and attributes.

Incidentally, as a common image search not only for animals, there are known methods for outputting an image similar to an inputted image from search target images by utilizing AI (Artificial Intelligence) or the like.

### PRECEDING TECHNICAL REFERENCES

### Patent Document

Patent Document 1: Japanese Patent Application Laid-Open under No. 2016-224640

### SUMMARY

### Problem to be Solved

The animal search system described in Patent Document 1 simply compares the image of the desired animal and the animal identification information of the animal with the image and the animal identification information of the animals stored in a DB and calculates the similarity of each of the image and the animal identification information to perform matching. However, in order to perform matching, it is preferable to enable the search by comprehensively combining various requirements.

One object of the present disclosure is to enable an animal search by appropriately combining various requirements.

### Means for Solving the Problem

According to an example aspect of the present disclosure, there is provided a search device comprising:
an image feature calculation means configured to calculate an image feature based on an animal image of an animal;
an attribute feature calculation means configured to calculate an attribute feature based on attribute information of the animal;
an appearance feature generation means configured to generate an appearance feature based on the image feature and the attribute feature corresponding to the animal; and a similarity calculation means configured to calculate similarity between the animal image and a target animal image based on the appearance feature corresponding to the animal image and the appearance feature corresponding to the target animal image.

According to another example aspect of the present disclosure, there is provided a search method comprising:
calculating an image feature based on an animal image of an animal;
calculating an attribute feature based on attribute information of the animal;
generating an appearance feature based on the image feature and the attribute feature corresponding to the animal; and
calculating similarity between the animal image and a target animal image based on the appearance feature corresponding to the animal image and the appearance feature corresponding to the target animal image.

According to still another example aspect of the present disclosure, there is provided a recording medium recording a program, the program causing a computer to:
calculate an image feature based on an animal image of an animal;
calculate an attribute feature based on attribute information of the animal;
generate an appearance feature based on the image feature and the attribute feature corresponding to the animal; and
calculate similarity between the animal image and a target animal image based on the appearance feature corresponding to the animal image and the appearance feature corresponding to the target animal image.

### Effect

According to the present disclosure, it becomes possible to search for an animal by appropriately combining various requirements.

### BRIEF DESCRIPTION OF THE DRAWINGS

FIG. 1 is a diagram illustrating a configuration of a search system.

FIG. 2 is a block diagram showing a hardware configuration of a search device of a first example embodiment.

FIG. 3 is a block diagram showing a functional configuration of the search device of the first example embodiment.

FIG. 4 is a diagram for explaining a technique for calculating an image feature vector.

FIG. 5 is a diagram for explaining a technique for calculating an attribute feature vector.

FIG. 6 is an example of an input screen.

FIG. 7 is a diagram for explaining a technique for calculating an appearance feature vector.

FIG. 8 is an example of a search result screen.

FIG. 9 is a flowchart of search processing by the search device of the first example embodiment.

FIG. 10 is a block diagram showing a functional configuration of the search device of a second example embodiment.

FIG. 11 is a diagram for explaining a technique for calculating a total feature vector.

FIG. 12 is a flowchart of search processing by the search device of the second example embodiment.

FIG. 13 is an example of a selection screen

FIG. 14 is a block diagram showing a functional configuration of the search device of a third example embodiment.

FIG. 15 is a flowchart of search processing by the search device of the third example embodiment.

### EXAMPLE EMBODIMENTS

Preferred example embodiments of the present invention will be described with reference to the accompanying drawings.

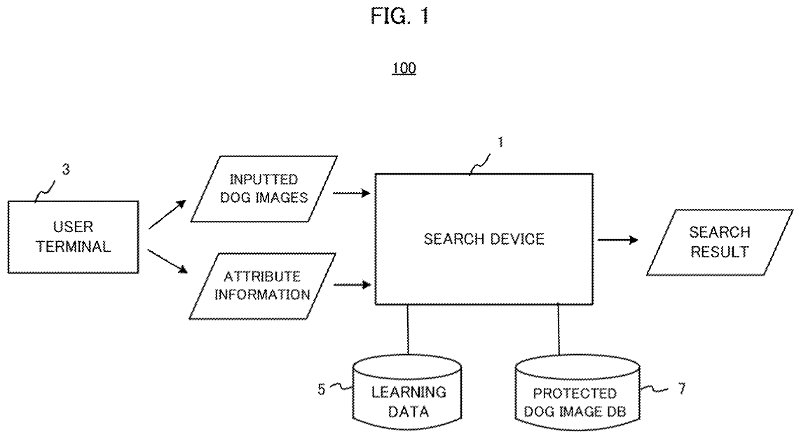

### First Example Embodiment

[Overall Configuration] FIG. 1 illustrates a configuration of a search system 100 to which the search device of the present disclosure is applied. The search system 100 is a system for searching for a protected animal similar to a search target animal designated by an image and an attribute information of the animal inputted by a user, and includes a search device 1 and a user terminal 3.

Here, the animals that can be searched by the search system 100 include, but are not limited to, dogs, cats, rabbits, birds, reptiles such as snakes, and the like. In the this example embodiment, a dog or a cat is mainly used as an animal to be handled by the search system 100.

The search device 1 includes learning data 5 and a protected dog image database (DB) 7. The search device 1 is a device that performs the image search of the protected dogs based on the user input. The user terminal 3 is a variety of terminal devices such as a smart phone, a tablet, a desktop PC, a laptop PC used by the user, and is a terminal to which the user inputs images and attributes of a favorite dog to search for a protected dog.

It should be noted that the protected dogs are dogs that are protected by facilities such as health centers and animal welfare organizations because they were thrown away or lost and their owner does not exist or is unknown, for example. In the present example embodiment, although the protected dogs are searched by the image and the attribute information of the dog for convenience of explanation, it is naturally possible to search the protected cats by the image and the attribute information of the cat.

The user inputs the dog image and the attribute information of the search target dog using the user terminal 3, and transmits the information to the search device 1 through the network. The search device 1 receives the dog image and attribute information from the user terminal 3. The search device 1 executes an image search for the protected dog from the protected dog image DB 7 based on the dog image and the attribution information, taking into account both the user's intended appearance and the inside.

[Hardware Configuration]

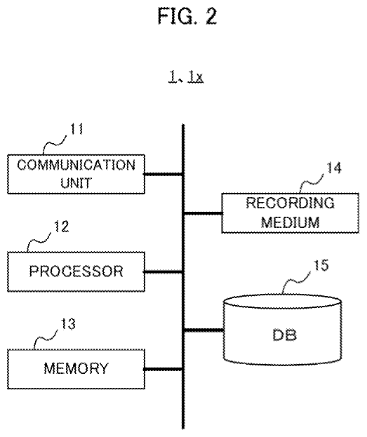

FIG. 2 is a block diagram illustrating a hardware configuration of a search device 1 according to the first example embodiment. As shown, the search device 1 includes a communication unit 11, a processor 12, a memory 13, a recording medium 14, and a database 15.

The communication unit 11 communicates with an external device. Specifically, the communication unit 11 is used to receive the dog image and the attribute information inputted by the user from the user terminal 3 and to transmit the search result to the user terminal 3.

The processor 12 is a computer such as a CPU (Central Processing Unit) and controls the entire search device 1 by executing a program prepared in advance. The processor 12 may be a GPU (Graphics Processing Unit), a FPGA (Field-Programmable Gate Array), a DSP (Demand-Side Platform), an ASIC (Application Specific Integrated Circuit), or the like. The processor 12 executes search processing described later by executing a program prepared in advance.

The memory 13 may include a ROM (Read Only Memory) and a RAM (Random Access Memory). The memory 13 stores various programs executed by the processor 12. The memory 13 is also used as a working memory during various processes performed by the processor 12.

The recording medium 14 is a non-volatile and non-transitory recording medium such as a disk-like recording medium or a semiconductor memory, and is configured to be detachable from the search device 1. The recording medium 14 records various programs executed by the processor 12. When the search device 1 executes the search processing described later, the program recorded in the recording medium 14 is loaded into the memory 13 and executed by the processor 12.

The database 15 stores the learning data 5 used in the learning processing of the model used by the search device 1 and the protected dog image DB 7 including images of a plurality of protected dogs (hereinafter, also referred to as “protected dog images”). The learning data 5 includes dog images and correct answer labels for learning. In addition to the above, the search device 1 may include an input device such as a keyboard and a mouse, and a display device.

[Learning Data]

In the first example embodiment, the dog images for learning are divided into some groups on the basis of the similarity of appearance in advance and the learning data 5 in which the groups are assigned as the correct answer labels are prepared. The search device 1 may analyze the images and automatically set the groups based on each item of the attribute information when the attribute information such as the type, body type, and color of the eyes is associated with the image. For example, when the items of the attribute information include the type and the body type, the search device 1 sets the dog images having the same type and the same body type to the same group. Further, the search device 1 may analyze the images and automatically set the groups by clustering using the items of the attribute information as the explanatory variables.

By the way, dogs and cats, especially cats, have a very large variety of appearances, unlike humans. Therefore, when the groups are subdivided to improve the search accuracy, the number of images per group is reduced in the learning data 5.

As a first method for solving such a problem, multiple images of a single dog or a single cat may be used as the learning data 5. For example, several images of a certain dog are prepared and all of them are set to the same group. Further, the learning data 5 may be augmented by mirror image inversion of one predetermined dog image, for example.

As a second method, a single image may be processed to generate multiple images by using a conversion model in which conversion of a color tone or the like is learned or a preset conversion rule, and the generated image may be used as the learning data 5. For example, a conversion model learned to convert the hair color from brown to gray or a preset conversion rule can be used to convert the hair color of a brown tabby cat image to a silver tabby cat image. Similarly, the model may be learned to convert, not only the hair color, but also the eye color or the like. In addition, the conversion model can convert not only the color tone but also the shape, the pattern or the position of the ear. Thus, for example, by performing processing such as color tone conversion and pattern conversion, it is possible to create multiple images from a single cat image, thereby to augment the learning data 5.

[Functional Configuration]

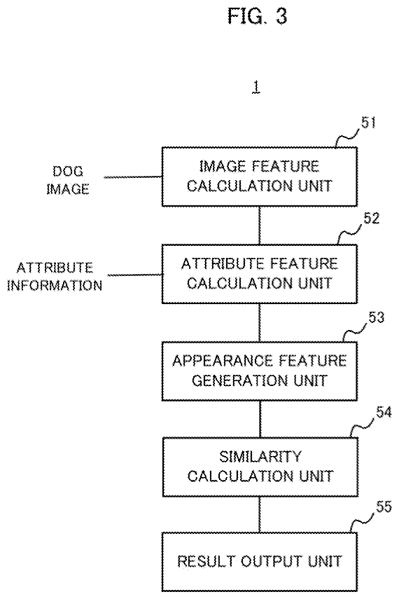

Next, a functional configuration of the search device 1 will be described. FIG. 3 is a block diagram showing a functional configuration of the search device 1. As illustrated, the search device 1 includes an image feature calculation unit 51, an attribute feature calculation unit 52, an appearance feature generation unit 53, a similarity calculation unit 54, and a result output unit 55. The image feature calculation unit 51, the attribute feature calculation unit 52, the appearance feature generation unit 53, the similarity calculation unit 54, and the result output unit 55 are realized by the processor 12.

The search device 1 calculates the feature vectors from the dog images by using metric learning. The search device 1 calculates the feature vectors so that the feature vectors calculated from similar dog images are located close to each other in the feature vector space and belong to the same group.

The metric learning is a technique by which a model using a neural network is learned so that the distance between two feature vectors reflects the similarity of the images. Specifically, the model is learned so that the distance between the feature vectors obtained from the images belonging to the same group is small and the distance between feature vectors obtained from the images belonging to different groups is large. As the learning of the model advances, the feature vectors calculated from the images with high similarity tend to be dense on the feature space, and the distance between the feature vectors calculated from the images with low similarity tends to be large. The distance here is, for example, digitized by the cosine similarity. As the value is closer to 1, the similarity is higher. While the cosine similarity is used in the present example embodiment, it is merely an example, and Euclidean distance or the like may be used. Using such a learned model, the search device 1 searches the protected dog image DB 7 for a protected dog image similar to the dog image that the user wants to search.

To the image feature calculation unit 51, a dog image is inputted via an image acquisition means not shown. The image acquisition means may be the communication unit 11 described above or an interface used by the user to input an image. The image feature calculation unit 51 calculates the image feature vector corresponding to the inputted dog image by using the image feature extraction model learned by the above-described metric learning.

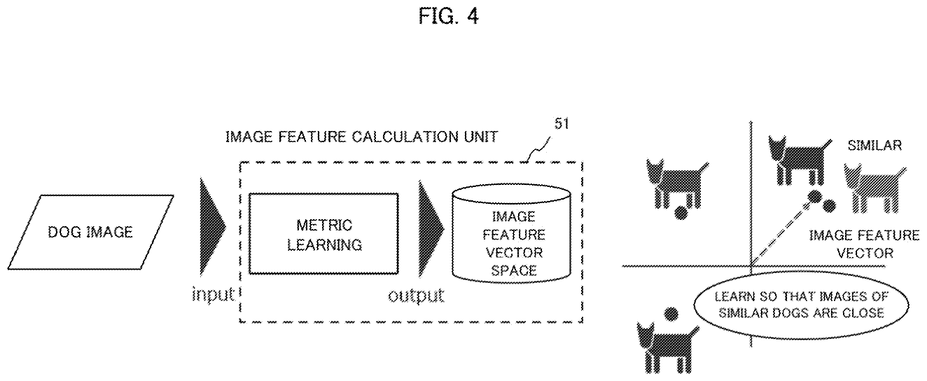

FIG. 4 is a diagram illustrating a technique by which the image feature calculation unit 51 calculates the image feature vector. As shown in FIG. 4, when the dog image is inputted, the image feature calculation unit 51 calculates the image feature vector in the image feature vector space using the image feature extraction model learned by the metric learning. The image feature extraction model clusters the image feature vectors extracted from the inputted images to generate the image feature vector space and calculates the image feature vector in the image feature vector space. Here, the image feature vector space is a space in which the distance between the feature vectors of the dog images with similar appearance becomes close.

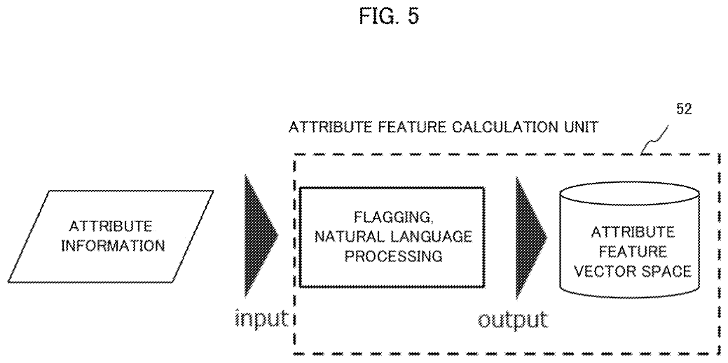

The attribute information of the dog corresponding to the dog image inputted to the image feature calculation unit 51 is inputted to the attribute feature calculation unit 52 through the attribute information acquisition means not shown. The attribute acquisition means may be the communication unit 11 described above or the interface for the user to input the image, for example. Here, the attribute feature is not an image feature but a non-image feature calculated based on the inputted attribute information. FIG. 5 is a diagram illustrating a technique by which the attribute feature calculation unit 52 calculates the attribute feature vector. As shown in FIG. 5, when the attribute information of the corresponding dog is inputted, the attribute feature calculation unit 52 calculates and outputs the attribute feature vector in the attribute feature vector space by flagging or natural language processing. Here, the attribute feature vector is a feature vector in which accuracy related to the appearance is improved and attribute information other than the appearance is also considered. The attribute feature vector space is a space in which the distance between the feature vectors of the dog images which are similar not only in appearance but also in attribute information other than appearance becomes close.

One effect of utilizing the attribute information in addition to the images is to improve the accuracy for the appearance. It is difficult to consider the size of dogs and cats only from the images, and there are cases in which the tail or the like are not captured in the image. In this respect, it is possible to improve the accuracy for the appearance by utilizing the attribute information. The second effect is to realize the search in consideration of the attribute information that cannot be recognized from the images, such as the character and an exercise amount of dogs and cats. The search for a protected dog or cat is often made by the user who is considering rearing dogs or cats in the future. In view of the search for actually rearing dogs or cats, only the information of the appearance is incomplete, and information such as personality and an exercise amount which cannot be considered from the images is useful. That is, by utilizing the attribute information in addition to the images, it becomes possible to make a search considering the attribute information which cannot be recognized from the images.

Specifically, the attribute information includes, but is not limited to, a type of animal, a pattern of body hair, a body weight, fur, a fur color, a fur length, an ear shape, an eye color, a tail shape, a body shape, a gender, an exercise amount, a meal quantity, personality, an age, a birthday, and a health status. The types of animal include dogs, cats, rabbits, birds, and reptiles such as snakes, and their types (the type of dog in case of dogs). The personality of the animal may be guessed based on the type, gender, age, or exercise amount of the pet, such as: A dog is relatively obedient to the owner. A cat is capricious, and a Chihuahua is small but aggressive. The pet is vigorous and active if the exercise amount is large.

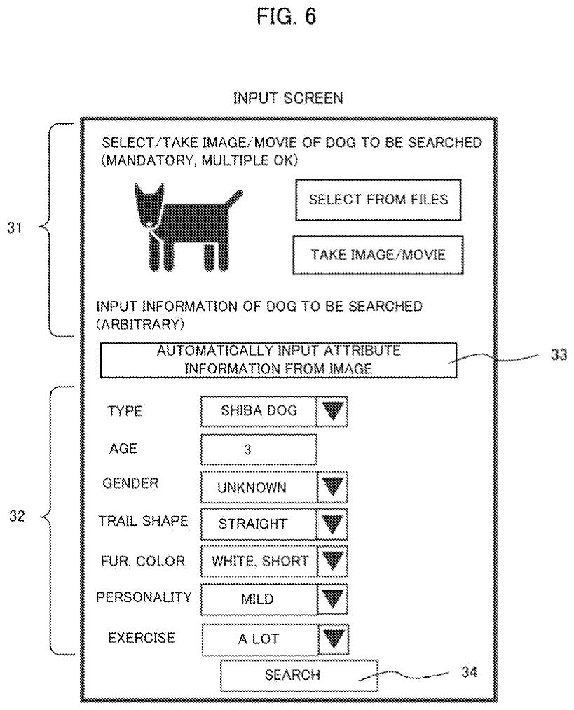

FIG. 6 is an example of an input screen. The input screen is a screen displayed on the user terminal 3, and the data inputted to the input screen is transmitted to the search device 1. Also, the data transmitted from the search device 1 to the user terminal 3 is reflected on the input screen. The input screen includes an item 31 for inputting a dog image to be searched by selecting a file of an image or a movie or by taking an image or a movie, items 32 for inputting the attribute information such as type, age, and gender, an automatic input button 33, and a search button 34. The user first inputs the desired dog image as the dog image to be searched. The inputted dog image is transmitted to the search device 1 and is inputted to the image feature calculation unit 51.

Then, the user enters the attribute information of the dog to be searched. The input of the attribute information may be performed manually by the user or automatically by the search device 1 based on the dog image. For example, in the case of manual input on the input screen shown in FIG. 6, the user selects an appropriate answer by the pull-down menu at each item 32 of the attribute information such as type and age. On the other hand, when the automatic input button 33 is pressed to perform the automatic operation, the attribute feature calculation unit 52 automatically determines the appropriate answer for each item 32 of the attribute information by analyzing the inputted dog image and displays it on the input screen. If there is an error in the answer to each item 32 automatically determined and displayed, the user may manually correct the error. In addition, the user may manually enter only the attribute information items that cannot be automatically determined from the image, such as character.

The attribute information inputted to the input screen is transmitted to the search device 1 when the search button 34 is pressed, and is inputted to the attribute feature calculation unit 52. Based on such attribute information, the attribute feature calculation unit 52 calculates and outputs the attribute feature vector in the attribute feature vector space by flagging or natural language processing. Specifically, the attribute feature calculation unit 52 can calculate the attribute feature vector by flagging, e.g., the gender of the attribute information as “male=0, female=1.” Further, the attribute feature calculation unit 52 can calculate the attribute feature vector by automatically taking out a part-of-speech and performing a natural language transformation process from the profile inputted by the protection organizations using AI (e.g., a natural language model generated by an existing technique).

As described above, the attribute feature calculation unit 52 calculates the attribute feature based on the inputted attribute information. However, particularly in the case of a protected dog, all items in the attribute information are not known, and a defect often exists. In that case, missing attribute information must be supplemented. As defect processing to complement the defect, there is a method to infer and complement the missing attribute information such as type, color, and shape of ear from the inputted dog image. In addition, when the missing attribute information cannot be complemented from the inputted dog image, a method of complementing the missing attribute information with statistics such as the average and the most frequent value of other dog images having common or similar attribute information can be used as the defect processing. According to this, the user may enter only the known items when inputting the attribute information. Even if a defect occurs, the attribute feature calculation section 52 can calculate and output the attribute feature by the defect processing without problem.

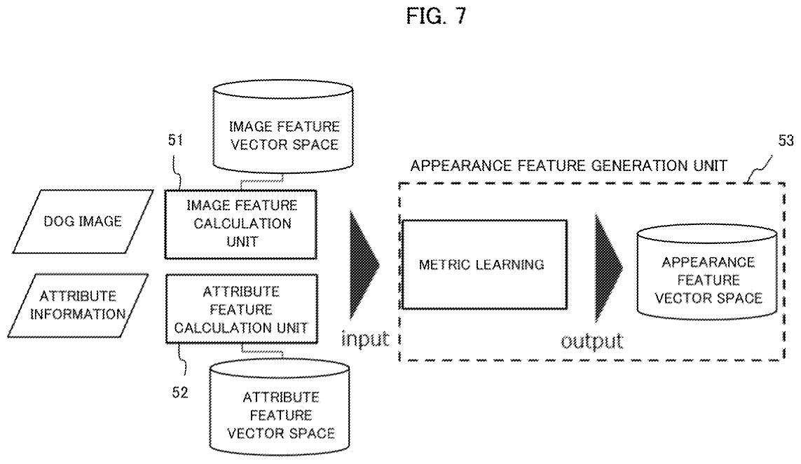

The image feature vector calculated by the image feature calculation unit 51 and the attribute feature vector calculated by the attribute feature calculation unit 52 are inputted to the appearance feature generation unit 53. FIG. 7 is a diagram illustrating a method by which the appearance feature generation unit 53 generates the appearance feature vector. As shown in FIG. 7, when the image feature vector and the attribute feature vector are inputted, the appearance feature generation unit 53 generates and outputs the appearance feature vector in the appearance feature vector space by synthesizing the image feature vector and the attribute feature vector by using metric learning. The scales of the image feature vector and the attribute feature vector may be different, and a simple summation may be impossible. Therefore, a new appearance feature vector space is generated by using the metric learning again, and the appearance feature vector in the new appearance feature vector space is calculated. For example, if the image feature vector is n-dimensional and the attribute feature vector is m-dimensional, the appearance feature vector may be (n+m)-dimensional, or may have any dimension by converting them into a new feature vector. Here, the appearance feature vector is a feature vector in which not only the appearance but also the attribute information other than the appearance are considered. The appearance feature vector space is such a space that the distance between the appearance feature vectors of the dog images in which the appearance and the attribute information other than the appearance are similar is close.

The similarity calculation unit 54 calculates the similarity of two images in the appearance feature vector space using the cosine similarity or the like based on the appearance feature vectors. Specifically, the similarity calculation unit 54 plots the appearance feature vectors of the dog image of search target inputted by the user and the respective protected dog images stored in the protected dog image DB 7 on the appearance feature vector space and calculates the similarity based on the distances of the images in the appearance feature vector space.

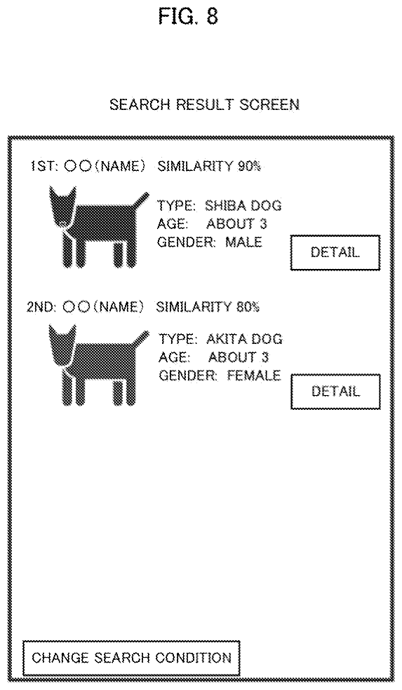

The result output unit 55 outputs the protected dog images as the search result based on the similarity calculated by the similarity calculation unit 54. FIG. 8 is an example of a search result screen. The search result screen is a screen displayed on the user terminal 3, and the protected dog images outputted by the result output unit 55 are displayed as the search result. The display method of the search result is arbitrary. For example, all the protected dog images whose similarity to the dog image of search target inputted by the user is larger than the threshold value may be displayed. Instead, the protected dog images with higher similarity may be displayed in the ranking format. Further, as shown in FIG. 8, the attribute information such as the similarity, name, type, age or gender may be displayed together with the protected dog image. The user can return to the input screen by pressing the button for changing the search condition on the search result screen and change the search condition such as the dog image and the attribute information to be searched.

[Search Processing]

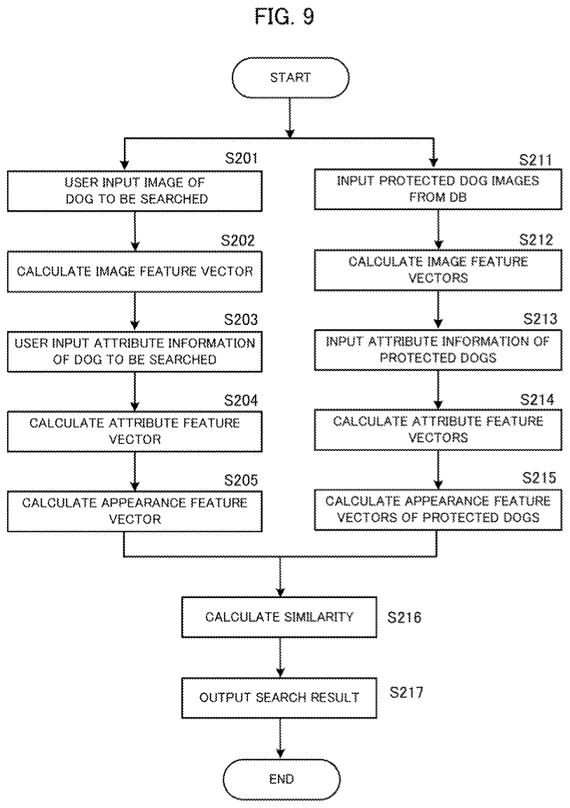

Next, search processing by the search device 1 will be described. FIG. 9 is a flowchart illustrating search processing executed by the search device 1. This processing is realized by the processor 12 shown in FIG. 2, which executes a program prepared in advance.

First, the search device 1 acquires a dog image and attribute information of a dog to be searched inputted by the user from the user terminal 3. When the dog image to be searched is inputted by the user (step S201), the image feature calculation unit 51 calculates and outputs the image feature vector using the image feature extraction model (step S202). Next, when the attribute information of the dog to be searched is inputted (step S203), the attribute feature calculation unit 52 calculates and outputs the attribute feature vector by flagging or natural language processing (step S204). Further, when the image feature vector and the attribute feature vector corresponding to the dog to be searched are inputted, the appearance feature generation unit 53 calculates and outputs the appearance feature vector (step S205). Thus, the appearance feature vector corresponding to the dog image that the user wants to search is calculated.

When the protected dog images stored in the protected dog image DB 7 are inputted (step S211), the image feature calculation unit 51 calculates the image feature vectors using the image feature extraction model (step S212). Next, when the attribute information of the protected dogs are inputted (step S213), the attribute feature calculation unit 52 calculates and outputs the attribute feature vectors by flagging or natural language processing (step S214). Further, when the image feature vectors and the attribute feature vectors corresponding to the protected dogs are inputted, the appearance feature generation unit 53 calculates and outputs the appearance feature vectors (step S215). Thus, the appearance feature vectors corresponding to all the protected dog images stored in the protected dog image DB 7 are calculated.

In the above description, although the process of steps S201 to S205 and the process of steps S211 and S215 are performed in parallel, it is not necessary to execute them in parallel. For example, the process of steps S211 to S215 may be executed after the process of steps S201 to S205, or vice versa.

Next, the similarity calculation unit 54 calculates the similarity between the dog image to be searched by the user and each protected dog image using the cosine similarity or the like based on the appearance feature vectors (step S216). Then, the result output unit 55 outputs the protected dog image whose similarity to the dog image to be searched by the user is larger than the threshold as the search result based on the similarity calculated by the similarity calculation unit 54 (step S217). Specifically, as shown in FIG. 8, the result output unit 55 displays the images of the outputted protected dog on the search result screen together with the attribute information. Thus, by monitoring the search result screen displayed on the user terminal 3, the user can confirm the images and attribute information of the protected dogs similar to the dog to be searched.

### Effect of the First Example Embodiment

As described above, the search system 100 of the first example embodiment can search for protected dogs similar to a favorite dog or a loved dog of the past with high accuracy by using the image and the attribute information of the dog that the user wants to search. In other words, since it is possible to improve the accuracy in view of appearance and perform the search in consideration of the attribute information other than appearance, the search result that matches the user's preference can be presented.

### MODIFIED EXAMPLES

Next, description will be given of modified examples of the first example embodiment. The following modified examples can be applied to the first example embodiment in appropriate combination.

### First Modified Example

Images of dogs and cats may be taken at various magnifications and angles. Therefore, the image feature for the same individual may change according to the difference of appearance. In this view, even for a plurality of images or moving images taken by different image-taking methods, the search device 1 may correct the magnification and/or angle of each inputted image to finally output truly-similar images as the search result. Thus, the accuracy in the image search can be stabilized.

The above search system 100 may be applied to the search for the protected dogs that are similar in appearance to a favorite dog image such as a beloved dog in the past, the search for the protected dogs that are not similar in appearance to a favorite dog image but match the user's preference, and the search for the lost beloved dog.

### Second Modified Example

Although the first example embodiment is directed to the search for dogs or cats, it should be understood that this disclosure is not limited thereto and may be directed to any pets such as a rabbit or hamster. In addition, although the search target is a protected dog or a protected cat in the first example embodiment, the present disclosure is not limited thereto, and the search target can be any pet animal regardless of whether or not it is protected. Further, an image other than the animal, e.g., an image such as other living things, objects, scenery, and the like, may be inputted as an input image to search for an animal similar to the image. By this, it becomes possible to search for an animal similar to the face of the user or other person by inputting a face image of the user or other person, or to search an animal similar to a soccer ball by inputting an image of a soccer ball, for example.

### Third Modified Example

In the first example embodiment, the feature vector obtained by vectorizing the feature by metric learning is used. However, the present invention is not limited thereto, and the feature of the scalar quantity, not vectorized, may be applied.

### Second Example Embodiment

Next, a second example embodiment of the present disclosure will be described. Since the overall configuration and the hardware configuration of the search device 1x according to the second example embodiment are the same as those of the first example embodiment, the description thereof will be omitted.

[Functional Configuration]

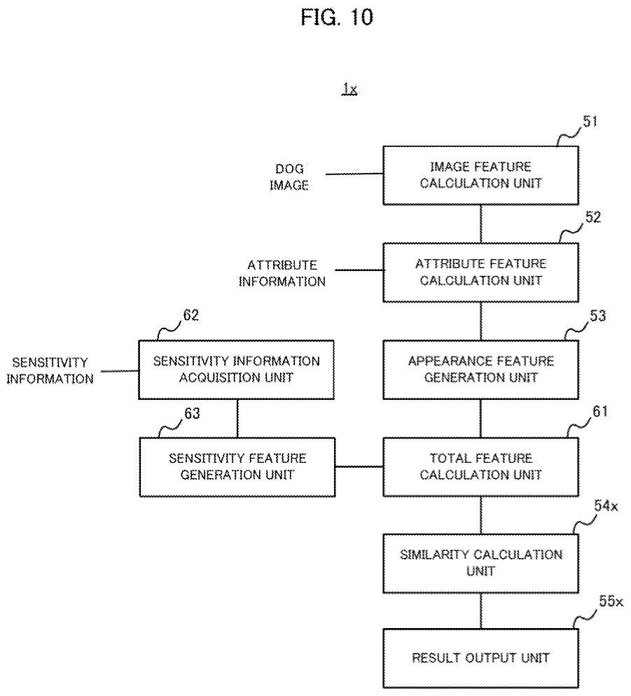

FIG. 10 is a block diagram showing a functional configuration of the search device 1x. The search device 1x includes an image feature calculation unit 51, an attribute feature calculation unit 52, an appearance feature generation unit 53, a total feature calculation unit 61, a similarity calculation unit 54x, a result output unit 55x, a sensitivity information acquisition unit 62, and a sensitivity feature calculation unit 63. Since the image feature calculation unit 51, the attribute feature calculation unit 52, and the appearance feature generation unit 53 are the same as those in the first example embodiment, the description thereof will not be repeated.

The search device 1x according to this example embodiment includes, in addition to the configuration of the search device 1 according to the first example embodiment, the sensitivity information acquisition unit 62 that acquires sensitivity information about a user's preference, and the sensitivity feature calculation unit 63 that calculates a sensitivity feature vector based on the sensitivity information about the user's preference.

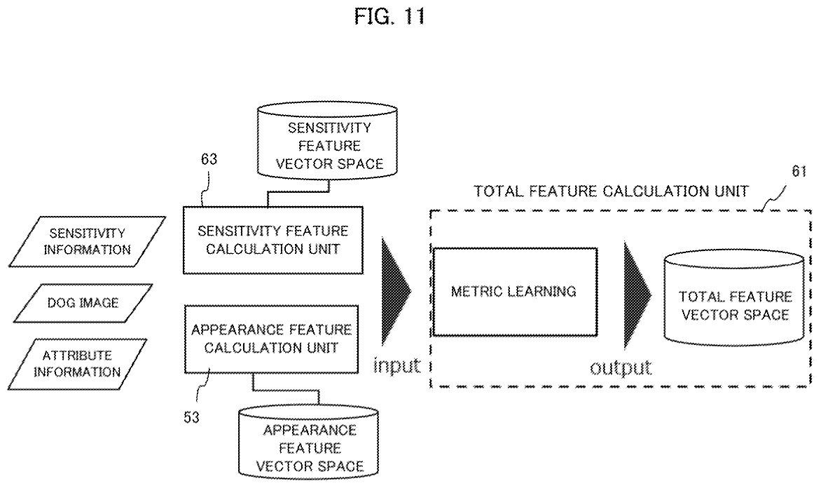

The appearance feature vector calculated by the appearance feature generation unit 53 and the sensitivity feature vector calculated by the sensitivity feature calculation unit 63 are inputted to the total feature calculation unit 61. FIG. 11 is a diagram illustrating a technique by which the total feature calculation unit 61 calculates the total feature vector. As shown in FIG. 11, when the appearance feature vector and the sensitivity feature vector are inputted, the total feature calculation unit 61 generates a total feature vector space by metric learning and calculates and outputs the total feature vector in the total feature vector space. Here, the total feature vector is a feature vector which is generated on the basis of the sensitivity feature vector related to human sensitivity including the user's preference to the appearance of animals, in addition to the appearance feature vector and the attribute feature vector. Also, the total feature vector space is such a space that the distance between the feature vectors of the dog images which suit the user's sensitivity becomes close to each other in addition to the attribute information of the appearance and the attribute information other than the appearance. Thus, by using the total feature vector which is generated based on the user's preference to the animals (e.g., favorite type, personality, fur) in addition to the appearance of the animal based on the image and the attributes of the animal, more appropriate matching of the user and the animals becomes possible.

In the second example embodiment, the learning data 5 is prepared by dividing the dog images for learning into groups based on human sensitivity and assigning the groups as the correct answer labels. For example, the images of the dogs in the same family are automatically set in the same group as the human preference matches. For example, the history of the images inputted by the user in advance is saved, and a plurality of dog images inputted by the same user are automatically set to the same group as the human preference matches. Further, for example, when a “Chihuahua” and a “Shiba dog” are raised in the same household, although the appearance and attribute information of them are not similar, it is guessed that a person who prefers a “Chihuahua” tends to prefer a “Shiba dog” and a “Chihuahua” and a “Shiba dog” are set in the same group.

Using the above learning data 5, learning of the model is executed so that the total feature vectors calculated not only from the appearances and the attribute information, but also from the image of the dog that fits the human sensitivity are close in the total feature vector space and belong to the same group. The total feature calculation unit 61 calculates the total feature vector using the model thus learned. Thus, the total feature calculation unit 61 can calculate the feature vector considering not only the appearance and the attribute information other than the appearance, but also the human sensitivity such as the user's preference.

The similarity calculation unit 54x calculates the similarity of the two images using the cosine similarity or the like on the basis of the total feature vectors. Specifically, the similarity calculation unit 54x plots the total feature vectors of the dog image that the user wants to search and the protected dog images stored in the protected dog image DB 7 on the total feature vector space and calculates the similarity based on the distance between the images in the total feature vector space.

The result output unit 55x outputs the protected dog images as the search result based on the similarity calculated by the similarity calculation unit 54x. At this time, the result output unit 55x may display a message indicating that it is a result of considering not only the appearance and attribute information but also the human sensitivity, such as “You may like this dog.”, together with the protected dog image in the search result screen.

[Search Processing]

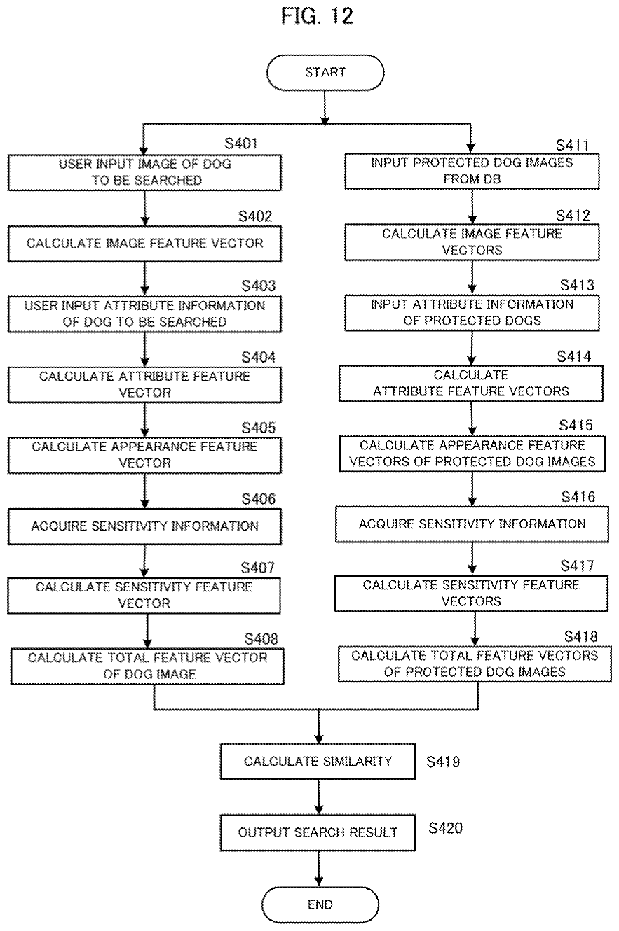

Next, search processing by the search device 1x will be described. FIG. 12 is a flowchart of search processing executed by the search device 1x. This processing is realized by the processor 12 shown in FIG. 2, which executes a program prepared in advance.

First, the search device 1x acquires the image and attribution data of the dog that the user inputs as a dog to be searched, from the user terminal 3. When the dog image to be searched is inputted by the user (step S401), the image feature calculation unit 51 calculates and outputs an image feature vector using the image feature extraction model (step S402). Next, when the attribute information of the dog to be searched is inputted (step S403), the attribute feature calculation unit 52 calculates and outputs the attribute feature vector by flagging or natural language processing (step S404). Further, when the image feature vector and the attribute feature vector corresponding to the dog to be searched are inputted, the appearance feature generation unit 53 calculates and outputs the appearance feature vector (step S405).

Next, the sensitivity information acquisition unit 62 acquires the sensitivity information (step S406), and the sensitivity feature calculation unit 63 calculates the sensitivity feature vector based on the sensitivity information (step S407). Then, when the appearance feature vector and the sensitivity feature vector are inputted, the total feature calculation unit 61 calculates and outputs the total feature vector (step S408). Thus, the total feature vector corresponding to the dog image that the user wants to search is calculated.

Also, when the protected dog images stored in the protected dog image DB 7 are inputted (step S411), the image feature calculation unit 51 calculates the image feature vectors using the image feature extraction model (step S412). Next, when the attribute information of the protected dogs are inputted (step S413), the attribute feature calculation unit 52 calculates and outputs the attribute feature vectors by flagging or natural language processing (step S414). Further, when the image feature vectors and the attribute feature vectors corresponding to the protected dogs are inputted, the appearance feature generation unit 53 calculates and outputs the appearance feature vectors (step S415).

Next, the sensitivity information acquisition unit 62 acquires the sensitivity information (step S416), and the sensitivity feature calculation unit 63 calculates the sensitivity feature vector based on the sensitivity information (step S417). When the appearance feature vectors and the sensitivity feature vector are inputted, the total feature calculation unit 61 calculates and outputs the total feature vectors (step S418). Thus, the total feature vectors corresponding to all the protected dog images stored in the protected dog image DB 7 are calculated.

While the process of steps S401 to S408 is executed in parallel with the process of steps S411 to S418 in the above description, it is not necessarily execute them in parallel. For example, the process of steps S411 to S418 may be executed after the process of steps S408 to S401, or vice versa.

Next, the similarity calculation unit 54x calculates the similarity between the dog image that the user wants to search and the respective protected dog images using the cosine similarity or the like based on the total feature vector corresponding to the dog image that the user wants to search and the total feature vectors corresponding to the protected dog images (step S419). Then, the result output unit 55x outputs the protected dog images having the similarity to the dog image that the user wants to search larger than a threshold, as the search result on the basis of the similarity calculated by the similarity calculation unit 54x (step S420). Specifically, as shown in FIG. 8, the result output unit 55x displays the images of the protected dogs in the search result screen together with the attribute information. Thus, by monitoring the search result screen displayed on the user terminal 3, the user can confirm the image and attribute information of the protected dogs similar to the dog to be searched.

### Effect of the Second Example Embodiment

According to the second example embodiment, an image search can be performed in consideration of not only the appearance and attribute information but also the human sensitivity. Therefore, a search result that matches the user's preference can be provided even if the user does not intend. That is, it is possible to present a protected dog image that suits the user's preference as a search result, even if the image of the dog is not similar to the dog image that the user wants to search in appearance.

### MODIFIED EXAMPLES

Next, description will be given of modified examples of the second example embodiment. The following modified examples can be applied to the second example embodiment in appropriate combination. The first to third modified examples described in the first example embodiment can be similarly applied to the second example embodiment.

### Fourth Modified Example

In the second example embodiment, the total feature vector is calculated by generating a new total feature vector space by metric learning. However, the present disclosure is not limited to this, and the feature of the image inputted by the users whose preference is similar to the user's preference may be used without generating a new vector space.

Specifically, when the user A inputs a dog image A that he or she wants to search, the search device 1x estimates a similar user who has the preference similar to the user A. As the estimation methods of the similar user, there are a method of estimating a group of users who have inputted the image similar to the input image of the user A as the similar users, and a method of estimating a group of users who have the profile information similar to the profile information of the user A as the similar users. In other words, the search device 1x can cluster the users based on the history of images inputted in the past and the user's profile information, and estimate the group of users having the preference similar to the user A's preference as the similar users.

The search device 1x acquires one or more dog images B that are not similar to the dog image A from the dog images previously inputted by the user B, who is presumed to be the similar user. Then, the search device 1x executes an estimation process on both the dog image A and the dog image B and outputs the protected dog image similar to each of the dog image A and the dog image B as the search result. The search device 1x displays the protected dog image similar to the dog image A and the protected dog image similar to the dog image B on the search result screen, respectively. At that time, the search device 1x may display a message indicating that is the result is obtained by considering not only the appearance and attribute information but also the human sensitivity, such as “A person similar to you also likes this dog.” together with the protected dog image similar to the dog image B.

According to this, for example, when the user A inputs the image of “Chihuahua” as a dog image to be searched, the search device 1x first estimates a similar user B having similar preference to the user A. Then, if the similar user B inputted “Shiba dog” other than “Chihuahua” as a dog image to be searched in the past, the search device 1x outputs the protected dog image similar to the image of “Chihuahua” inputted by user A and the protected dog image similar to the image of “Shiba dog” inputted by the similar user B in the past as the search result.

### Fifth Modified Example

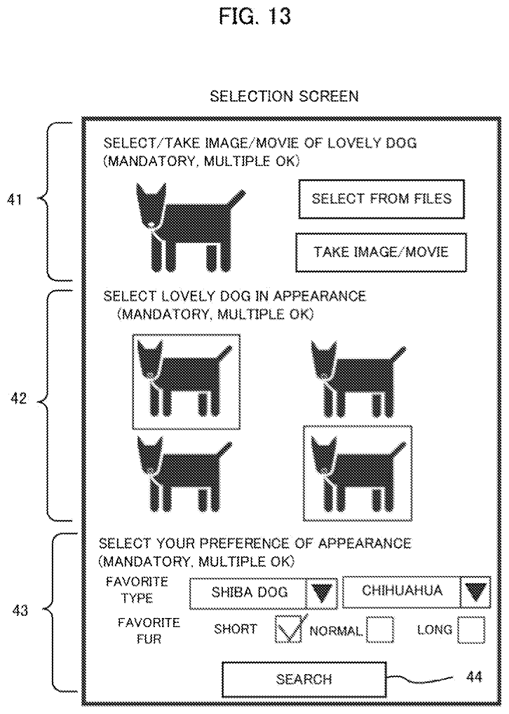

In the second example embodiment, the sensitivity feature vector is calculated using the sensitivity information inputted by the user. FIG. 13 is an example of a selection screen for the user to input the sensitivity information. The selection screen is a screen displayed on the user terminal 3, and the data entered or selected in the selection screen is transmitted to the search device 1x. The selection screen includes an item 41 for inputting an image of a dog that the user thinks lovely by selecting a file or taking an image, an item 42 for selecting a dog image that the user thinks lovely in appearance from among a plurality of dog images, an item 43 for selecting user's preference concerning the appearance such as a favorite type and fur, and a search button 44. When the user makes an input or selection and presses the search button 44, the user terminal 3 transmits these data to the search device 1x as the sensitivity information. The search device 1x may calculate the sensitivity feature vector based on the sensitivity information of the user thus acquired. This modified example enables more appropriate matching because users' preferences, which are difficult to be verbalized, can be properly considered.

In the case of the description of FIG. 13, the sensitivity information acquisition unit 62 acquires an animal image that matches the user's preference from the user, as the sensitivity information, from among a plurality of animal images. The sensitivity feature calculation unit 63 calculates the sensitivity feature vector based on the acquired animal image. The total feature calculation unit 61 generates the total feature based on the image feature vector corresponding to the animal, the attribute feature vector, and the sensitivity feature vector. The similarity calculation unit 54x calculates the similarity with the target animal based on the total feature. Thus, it is possible to perform matching in consideration of the sensitivity information related to the user's preference.

### Third Example Embodiment

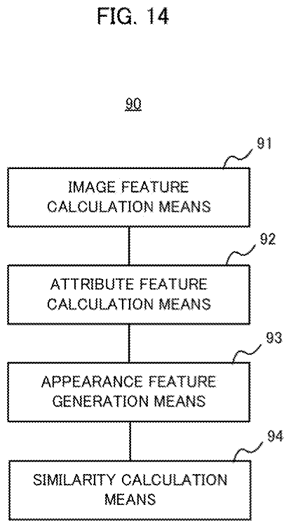

FIG. 14 is a block diagram showing a functional configuration of a search device of a third example embodiment. The search device 90 includes an image feature calculation means 91, an attribute feature calculation means 92, an appearance feature generation means 93, and a similarity calculation means 94. The image feature calculation means 91 calculates an image feature based on an animal image of an animal. The attribute feature calculation means 92 calculates an attribute feature based on attribute information of the animal. The appearance feature generation means 93 generates an appearance feature based on the image feature and the attribute feature corresponding to the animal. The similarity calculation means 94 calculates similarity between the animal image and a target animal image based on the appearance feature corresponding to the animal image and the appearance feature corresponding to the target animal image.

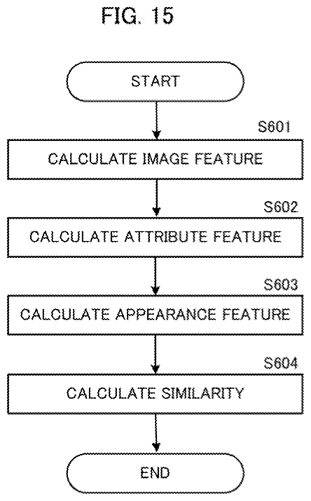

FIG. 15 is a flowchart of search processing executed by the search device 90. The image feature calculation means 91 calculates an image feature based on an animal image of an animal (step S601). The attribute feature calculation means 92 calculates an attribute feature based on attribute information of the animal (step S602). The appearance feature generation means 93 generates an appearance feature based on the image feature and the attribute feature corresponding to the animal (step S603). The similarity calculation means 94 calculates similarity between the animal image and a target animal image based on the appearance feature corresponding to the animal image and the appearance feature corresponding to the target animal image (step S604).

### Effect of the Third Example Embodiment

According to the search device of the third example embodiment, it is possible to search for similar animals based on not only the image of the animal but also the appearance feature considering the attribute of the animal.

A part or all of the example embodiments described above may also be described as the following supplementary notes, but not limited thereto.

(Supplementary Note 1)

A search device comprising:
an image feature calculation means configured to calculate an image feature based on an animal image of an animal;
an attribute feature calculation means configured to calculate an attribute feature based on attribute information of the animal;
an appearance feature generation means configured to generate an appearance feature based on the image feature and the attribute feature corresponding to the animal; and
a similarity calculation means configured to calculate similarity between the animal image and a target animal image based on the appearance feature corresponding to the animal image and the appearance feature corresponding to the target animal image.

(Supplementary Note 2)

The search device according to Supplementary note 1, further comprising a result output means configured to output the target animal image based on the similarity.

(Supplementary Note 3)

The search device according to Supplementary note 1 or 2, wherein the attribute information includes at least one of a type of animal, a pattern of body hair, a body weight, fur, a fur color, a fur length, an ear shape, an eye color, a tail shape, a body shape, a gender, an exercise amount, a meal quantity, personality, an age, a birthday, and a health status.

(Supplementary Note 4)

The search device according to any one of Supplementary notes 1 to 3, wherein the attribute feature calculation means acquires the attribute information by analyzing the image.

(Supplementary Note 5)

The search device according to any one of Supplementary notes 1 to 4, further comprising:
a sensitivity information acquisition means configured to acquire sensitivity information related to a user's preference to the animals;
a sensitivity feature calculation means configured to calculate the sensitivity feature based on the sensitivity information; and
a total feature generation means configured to generate a total feature based on the image feature, the attribute feature, and the sensitivity feature corresponding to the animal.

(Supplementary Note 6)

The search device according to Supplementary note 5,
wherein the sensitivity information acquisition means acquires, from the user, an animal image suiting to the user's preference from among a plurality of animal images, as the sensitivity information,
wherein the sensitivity feature calculation means calculates the sensitivity feature based on the acquired animal image, and
wherein the total feature generation means generates the total feature based on the image feature, the attribute feature, and the sensitivity feature corresponding to the animal.

(Supplementary Note 7)

The search device according to any one of Supplementary notes 1 to 6, wherein the image feature calculation means divides the animal images into groups based on similarity of the animal images and calculates the image feature using a learned model which is learned using learning data to which labels relating to the similarity are given.

(Supplementary Note 8)

The search device according to any one of Supplementary notes 1 to 4, further comprising a total feature calculation means configured to calculate a total feature considering a user's sensitivity, based on the appearance feature corresponding to the animal image and the appearance feature corresponding to the target animal image, respectively, wherein the similarity calculation means calculates the similarity between the animal image and the target animal image based on the total feature corresponding to the animal image and the total feature corresponding to the target animal image.

(Supplementary Note 9)

A search method comprising:
calculating an image feature based on an animal image of an animal;
calculating an attribute feature based on attribute information of the animal;
generating an appearance feature based on the image feature and the attribute feature corresponding to the animal; and
calculating similarity between the animal image and a target animal image based on the appearance feature corresponding to the animal image and the appearance feature corresponding to the target animal image.

(Supplementary Note 10)

A recording medium recording a program, the program causing a computer to:
calculate an image feature based on an animal image of an animal;
calculate an attribute feature based on attribute information of the animal;
generate an appearance feature based on the image feature and the attribute feature corresponding to the animal; and
calculate similarity between the animal image and a target animal image based on the appearance feature corresponding to the animal image and the appearance feature corresponding to the target animal image.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1, 1x Search device
3 User terminal
5 Learning data
7 Protected dog image database
11 Communication unit
12 Processor
13 Memory
14 Recording medium
15 Database
51 Image feature calculation unit
52 Attribute feature calculation unit
53 Appearance feature generation unit

What is claimed is:

1. A search device comprising:
a memory configured to store instructions; and
one or more processors configured to execute the instructions to:
calculate an image feature based on an animal image of an animal;
calculate an attribute feature based on attribute information of the animal;
generate an appearance feature based on the image feature and the attribute feature corresponding to the animal; and
calculate similarity between the animal image and a target animal image based on the appearance feature corresponding to the animal image and the appearance feature corresponding to the target animal image.

2. The search device according to claim 1, wherein the one or more processors are further configured to output the target animal image based on the similarity.

3. The search device according to claim 1, wherein the attribute information includes at least one of a type of animal, a pattern of body hair, a body weight, fur, a fur color, a fur length, an ear shape, an eye color, a tail shape, a body shape, a gender, an exercise amount, a meal quantity, personality, an age, a birthday, and a health status.

4. The search device according to claim 1, wherein the one or more processors acquire the attribute information by analyzing the image.

5. The search device according to claim 1, wherein the one or more processors are further configured to:
acquire sensitivity information related to a user's preference to the animals;
calculate the sensitivity feature based on the sensitivity information; and
generate a total feature based on the image feature, the attribute feature, and the sensitivity feature corresponding to the animal.

6. The search device according to claim 5,
wherein the one or more processors acquires, from the user, an animal image suiting to the user's preference from among a plurality of animal images, as the sensitivity information,
wherein the one or more processors calculates the sensitivity feature based on the acquired animal image, and
wherein the one or more processors generate the total feature based on the image feature, the attribute feature, and the sensitivity feature corresponding to the animal.

7. The search device according to claim 1, wherein the one or more processors divide the animal images into groups based on similarity of the animal images and calculate the image feature using a learned model which is learned using learning data to which labels relating to the similarity are given.

8. The search device according to claim 1,
wherein the one or more processors are further configured to calculate a total feature considering a user's sensitivity, based on the appearance feature corresponding to the animal image and the appearance feature corresponding to the target animal image, respectively, and
wherein the one or more processors calculate the similarity between the animal image and the target animal image based on the total feature corresponding to the animal image and the total feature corresponding to the target animal image.

9. A search method comprising:
calculating an image feature based on an animal image of an animal;
calculating an attribute feature based on attribute information of the animal;
generating an appearance feature based on the image feature and the attribute feature corresponding to the animal; and
calculating similarity between the animal image and a target animal image based on the appearance feature corresponding to the animal image and the appearance feature corresponding to the target animal image.

10. A non-transitory computer-readable recording medium recording a program, the program causing a computer to:
calculate an image feature based on an animal image of an animal;
calculate an attribute feature based on attribute information of the animal;
generate an appearance feature based on the image feature and the attribute feature corresponding to the animal; and
calculate similarity between the animal image and a target animal image based on the appearance feature corresponding to the animal image and the appearance feature corresponding to the target animal image.
